(19) United States
(12) Patent Application Publication
(10) Pub. No.: US 2023/0000302 A1
(43) Pub. Date: Jan. 5, 2023

(54) CLEANING AREA ESTIMATION DEVICE AND METHOD FOR ESTIMATING CLEANING AREA

(71) Applicant: SONY GROUP CORPORATION, TOKYO (JP)

(72) Inventors: HIDEKI OYAIZU, TOKYO (JP); AKINORI SHINGYOUCHI, KANAGAWA (JP)

(21) Appl. No.: 17/756,869

(22) PCT Filed: Dec. 4, 2020
(86) PCT No.: PCT/JP2020/045153

§ 371 Date: Jun. 3, 2022

(30) Foreign Application Priority Data
Dec. 13, 2019 (JP) 2019-225886

(51) Int. Cl. A47L 11/40; G06V 10/77; G06T 7/00

(52) U.S. Cl. CPC A47L 11/4011; G06V 10/7715; G06T 7/0008; A47L 2201/04; G06V 2201/07

(57) ABSTRACT

A cleaning area estimation device (30) includes an estimation unit (33) that estimates dirt information (D2) about an inside of a cleaning area on the basis of image information (D1) obtained by imaging a cleaning area by an imaging device (10), and a generation unit (34) that generates map information (D3) indicating a map of the dirt information about the cleaning area on the basis of the estimated time-series dirt information (D2).

### FIELD

The present disclosure relates to a cleaning area estimation device and a method for estimating a cleaning area.

### BACKGROUND

Patent Literature 1 discloses a technique for visualizing a cleaning state of an area to be cleaned by displaying an amount and a type of dirt in a room to be cleaned in a form of map and displaying them in augmented reality (AR) during cleaning.

### CITATION LIST

### Patent Literature

Patent Literature 1: JP 2019-82807 A

### SUMMARY

### Technical Problem

In the above conventional technique, an automatic cleaner needs to be operated in advance in the cleaning area in order to acquire dirt information.

In view of this, the present disclosure provides a cleaning area estimation device and a method for estimating a cleaning area, which are capable of supporting determination of necessity of cleaning by using image information obtained by imaging the cleaning area.

### Solution to Problem

To solve the problems described above, a cleaning area estimation device according to an embodiment of the present disclosure includes: an estimation unit configured to estimate dirt information about an inside of a cleaning area on a basis of image information obtained by imaging the cleaning area by an imaging device; and a generation unit configured to generate map information indicating a map of the dirt information about the cleaning area on a basis of the dirt information that is estimated and in a time series.

Moreover, a method for estimating a cleaning area according to an embodiment of the present disclosure includes: estimating, by a computer, dirt information about an inside of a cleaning area on a basis of image information obtained by imaging a cleaning area by an imaging device; and generating, by the computer, map information indicating a map of the dirt information about the cleaning area on a basis of the dirt information that is estimated and in a time series.

### BRIEF DESCRIPTION OF DRAWINGS

FIG. 1 is a diagram illustrating an example of a configuration of a cleaning area estimation system according to a first embodiment.

FIG. 2 is a diagram illustrating an example of the relationship between an imaging device and a cleaning area according to the first embodiment.

FIG. 3 is a diagram for explaining an example of an area to be extracted from the cleaning area according to the first embodiment.

FIG. 4 is a diagram illustrating an example of the relationship between time and an accumulated amount of dirt of the cleaning area according to the first embodiment.

FIG. 5 is a diagram illustrating an example of map information according to the first embodiment.

FIG. 6 is a flowchart illustrating an example of a processing procedure executed by a cleaning area estimation device according to the first embodiment.

FIG. 7 is a diagram illustrating an example of a configuration of a cleaning area estimation system according to a modification of the first embodiment.

FIG. 8 is a diagram for explaining the relationship between an object and the degree of ease with which dust accumulates.

FIG. 9 is a diagram illustrating an example of a configuration of a cleaning area estimation system according to a second embodiment.

FIG. 10 is a flowchart illustrating an example of a processing procedure executed by a cleaning area estimation device according to the second embodiment.

FIG. 11 is a diagram for explaining an example of dirt in the cleaning area.

FIG. 12 is a diagram illustrating an example of a configuration of a cleaning area estimation system according to a third embodiment.

FIG. 13 is a flowchart illustrating an example of a processing procedure executed by a cleaning area estimation device according to the third embodiment.

FIG. 14 is a diagram illustrating an example of map information generated by the cleaning area estimation device according to the third embodiment.

FIG. 15 is a hardware configuration diagram illustrating an example of a computer that implements functions of a cleaning area estimation device.

### DESCRIPTION OF EMBODIMENTS

Hereinafter, embodiments of the present disclosure will be described in detail with reference to the drawings. In the following embodiments, the same parts are denoted by the same reference signs, and redundant description will be omitted.

### First Embodiment

### Outline of Cleaning Area Estimation System According to First Embodiment

Cleaning removes trash, dust, dirt, and the like. In cleaning periodically performed in an office building, a warehouse, or the like, each room is cleaned regardless of the presence or absence of dirt, which increases the cost required for cleaning. For example, if a place to be intensively cleaned and a place requiring only light cleaning can be discriminated, the time allocation for cleaning can be changed, and more efficient cleaning can be realized in the same time. However, an amount and a type of dirt needs to be actually checked and determined by a person who performs cleaning. For this reason, an operation occurs in which a cleaning person, a cleaning robot, or the like always visits and checks a room that does not actually need to be cleaned. There is hereby provided a cleaning map in which a cleaning area where cleaning is required can be estimated and the need for a check operation that entails going out to the cleaning area can be eliminated. The cleaning area includes, for example, a three-dimensional area and a planar area.

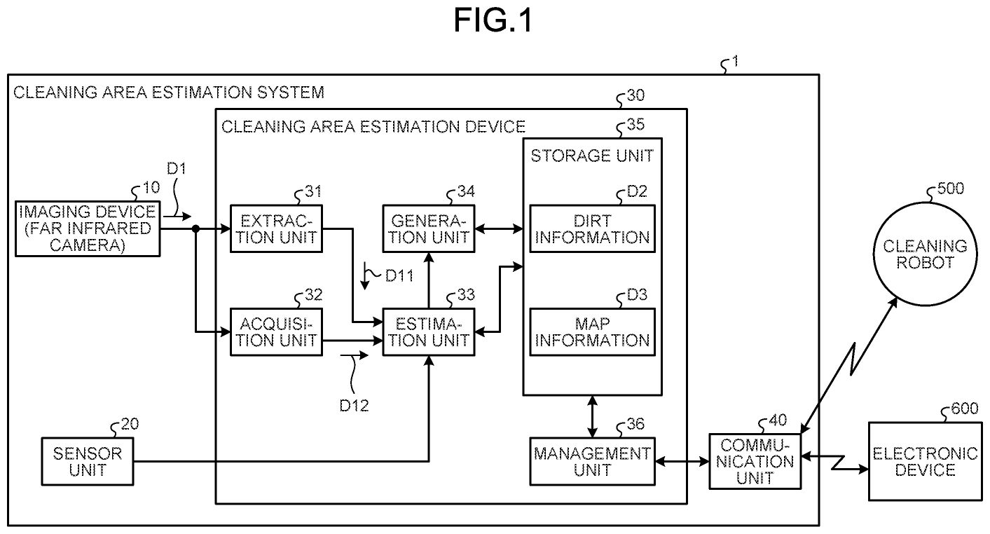

FIG. 1 is a diagram illustrating an example of a configuration of a cleaning area estimation system according to a first embodiment. As illustrated in FIG. 1, a cleaning area estimation system 1 includes an imaging device 10, a sensor unit 20, a cleaning area estimation device 30, and a communication unit 40. The cleaning area estimation device 30 is electrically connected to the imaging device 10, the sensor unit 20, and the communication unit 40, and is configured to be able to transfer and receive various types of information. The cleaning area estimation device 30 estimates the state of dirt of the cleaning area on the basis of the image captured by the imaging device 10, the detection result of the sensor unit 20, and the like. The image includes, for example, a moving image, a still image, and the like.

The imaging device 10 is provided to be able to image the cleaning area. The imaging device 10 includes, for example, a single or a plurality of cameras installed in the cleaning place. The imaging device 10 includes, for example, a far infrared camera, a visible light camera, a polarization camera, a time of flight (ToF) camera, an RGB camera, a stereo camera, a depth camera. The imaging device 10 may be configured to divide the cleaning area into a plurality of areas and to image each of the divided areas by a plurality of cameras. The imaging device 10 supplies the captured image information to the cleaning area estimation device 30.

For example, when sweat adheres to a table, a chair, a wall, or the like touched by a person due to temperature or humidity, the adhered portion becomes dirty. Similarly, for example, a portion of an object where an animal such as a pet has come in contact with becomes dirty. As such, an example in a case where the imaging device 10 is a far infrared camera will be described in the first embodiment in order to, for example, estimate motions of a person.

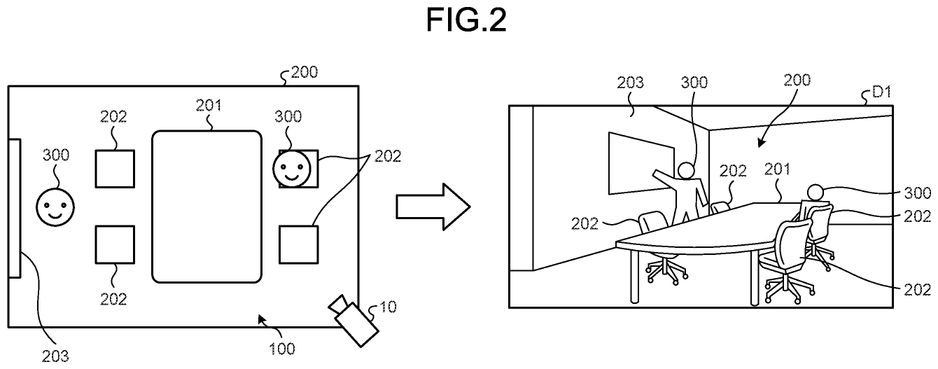

FIG. 2 is a diagram illustrating an example of the relationship between the imaging device 10 and a cleaning area 100 according to the first embodiment. As illustrated in FIG. 2, the imaging device 10 images the inside of a room 200 to be cleaned. The room 200 includes a table 201, four chairs 202, and a whiteboard 203. The room 200 is used by two persons 300. The imaging device 10 images an imaging area including part or all of the cleaning area 100. The cleaning area 100 includes, for example, a floor of the room 200, the table 201, the chairs 202, the whiteboard 203, and the like and includes an area requiring determination whether or not to perform cleaning. The cleaning area 100 may be the entire area of the room 200 or a partial area of the room 200. The imaging device 10 captures image information D1 with which the temperature can be identified. The image information D1 includes an infrared image. The image information D1 includes, for example, an image indicating that the temperature of a portion where the person 300 is present is higher than the ambient temperature in the room 200. In the example illustrated in FIG. 2, the image information D1 indicates that the temperature of the areas of the person 300 seated on the chair 202 and the person 300 using the whiteboard 203 are higher than the ambient temperature. Further, the image information D1 at different time indicates that the temperature of the areas of the two persons 300 seated on the chair 202 are higher than the ambient temperature. Accordingly, the image information D1 can indicate the area where the person 300 is present in the cleaning area 100 in a time series.

The sensor unit 20 is provided in or near the cleaning area 100. The sensor unit 20 includes, for example, a sensor such as a temperature sensor, a humidity sensor, an ultrasonic sensor, a radar, a light detection and ranging or laser imaging detection and ranging (LiDAR), or a sonar. The sensor unit 20 supplies the measured sensor information to the cleaning area estimation device 30. The sensor information includes, for example, temperature, humidity, distance to an object, measurement date and time, and the like.

For example, it is known that the amount of sweat of the person 300 is obtained by the relationship of an environmental temperature, humidity, a sweating rate, and the like. As a method of obtaining the sweating rate, it is possible to refer to the description of Reference Literature 1 “Wang, Shugang, et al. ‘Hot environment-estimation of thermal comfort in deep underground mines.’ (2012)”. As can be seen from the above, the amount of sweat discharged from the human body can be estimated if the room temperature and the humidity are provided. The sensor unit 20 supplies measurement information indicating the measured temperature, humidity, and the like of the cleaning area 100 to the cleaning area estimation device 30, thereby enabling estimation of how much and in which area of the cleaning area 100 sweat is accumulated.

Returning to FIG. 1, the communication unit 40 communicates with a cleaning robot 500, an electronic device 600, and the like outside the cleaning area estimation device 30. The communication unit 40 transmits various types of information from the cleaning area estimation device 30 to the electronic device that is a transmission destination. The communication unit 40 supplies the various types of information received therefrom to the cleaning area estimation device 30. In the example illustrated in FIG. 1, the cleaning robot 500 is an autonomous mobile cleaning robot. The cleaning robot 500 is, for example, a robot that includes a cleaning unit, avoids collision with an obstacle, and cleans while moving to a target point. The electronic device 600 includes, for example, a smartphone, a tablet terminal, a personal computer, a home appliance, and the like. The communication protocol supported by the communication unit 40 is not particularly limited, and the communication unit 40 can support a plurality of types of communication protocols. The communication unit 40 functions as a communication means of the cleaning area estimation device 30.

### Configuration Example of Cleaning Area Estimation Device According to First Embodiment

Next, an example of a functional configuration of the cleaning area estimation device 30 according to the first embodiment will be described. The cleaning area estimation device 30 includes an extraction unit 31, an acquisition unit 32, an estimation unit 33, a generation unit 34, a storage unit 35, and a management unit 36. Each functional unit of the extraction unit 31, the acquisition unit 32, the estimation unit 33, the generation unit 34, and the management unit 36 is, for example, implemented by executing a program stored in the inside of the cleaning area estimation device 30 using a random access memory (RAM) or the like as a work area by a central processing unit (CPU), a micro control unit (MCU), or the like.

Furthermore, each functional unit may be implemented by, for example, an integrated circuit such as an application specific integrated circuit (ASIC) or a field-programmable gate array (FPGA).

The extraction unit 31 extracts an area satisfying an extraction condition from the image information D1 obtained by shooting the cleaning area 100 by the imaging device 10. The extraction condition includes, for example, a condition for extracting a feature area such as an area where the person 300 is present, an area where the person 300 is not present, and a used area in the cleaning area 100. In other words, the feature area is an area inside the cleaning area 100. The extraction unit 31 supplies, to the estimation unit 33, area information D11 indicating the feature area extracted from the image information D1.

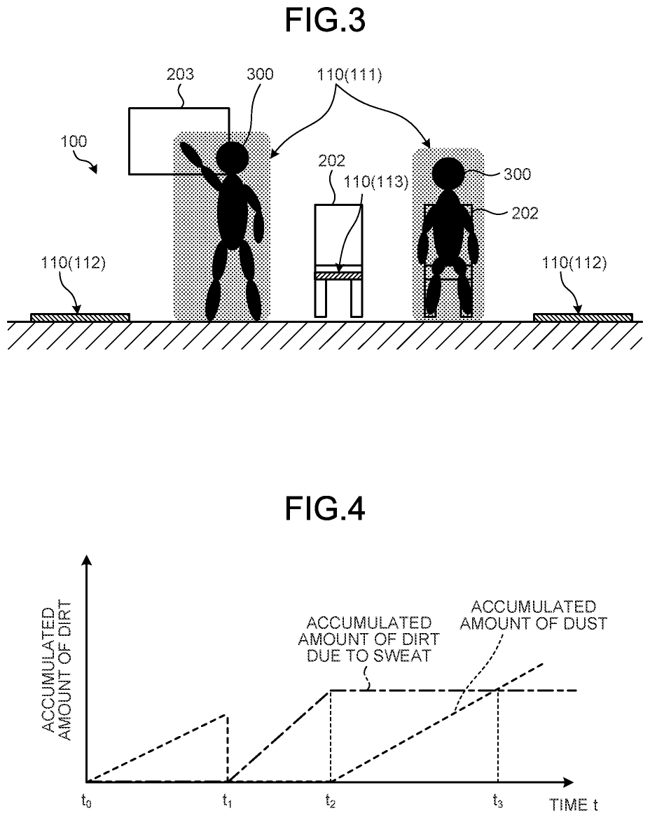

FIG. 3 is a diagram for explaining an example of an area to be extracted from the cleaning area 100 according to the first embodiment. FIG. 3 illustrates the relationship between the table 201 and the persons 300 and between the whiteboard 203 and the persons 300 in FIG. 2, as a schematic diagram. In the example illustrated in FIG. 3, the extraction unit 31 extracts a feature area 110 such as an area 111, an area 112, and an area 113 from the image information D1. The area 111 is, for example, an area where the person 300 is present and that may be dirtied by sweat, sebum, or the like of the person 300. The area 112 is an area where the person 300 does not enter, and is an area where dust easily accumulates. In other words, the area 112 is an area that may be dirtied with dust. The area 113 is an area that may be dirtied with both sweat and dust. The extraction condition includes a condition for extracting at least one of the area 111, the area 112, the area 113, and the like. The extraction condition of the area 111 includes, for example, a condition for extracting the whole or part of the person 300 who is a living thing in the cleaning area 100. The extraction condition of the area 112 includes, for example, a condition for extracting an area where the person 300 is not present or an area around the moving person 300 in the cleaning area 100. The extraction condition of the area 113 includes, for example, a condition for extracting an area of an object used by the person 300 in the cleaning area 100. Examples of the object include the table 201, the chair 202, the whiteboard 203, a desk, a wall, a floor, and the like.

Returning to FIG. 1, the acquisition unit 32 acquires feature information indicating a feature of the cleaning area 100 from the image information D1. For example, when the image information D1 includes information indicating temperature, the acquisition unit 32 acquires additional information D12 indicating the temperature of the cleaning area 100. That is, the acquisition unit 32 acquires the additional information D12 indicating the temperature of the person 300 from the image information D1. The acquisition unit 32 supplies, to the estimation unit 33, the additional information D12 acquired from the image information D1.

The estimation unit 33 estimates dirt information D2 about the inside of the cleaning area 100 on the basis of the area information D11 and the additional information D12 of the image information D1, and measurement information (humidity) of the sensor unit 20. The estimation unit 33 identifies a feature of the feature area 110 on the basis of the area information D11 and the additional information D12, and estimates the dirt information D2 on the basis of the feature. In a case where the feature area 110 of the area information D11 is the area 111, when the area 111 is specified as a living thing, the estimation unit 33 estimates the dirt information D2 corresponding to the living thing. For example, when the living thing is the person 300, the estimation unit 33 estimates the amount of sweat of the person 300 on the basis of temperature, humidity, and the like of the feature area 110, and stores the estimation result in the storage unit 35 as the dirt information D2 about the feature area 110. The dirt information D2 includes, for example, information such as imaging date and time of the image information D1, a type of the feature area 110, and an estimation result of dirt. For example, when the living thing is an animal, the estimation unit 33 estimates dirt due to the animal on the basis of temperature, humidity, a type of animal of the area 111, and the like, and stores the estimation result in the storage unit 35 as the dirt information D2 about the feature area 110.

When the feature area 110 of the area information D11 is the area 112, the estimation unit 33 estimates the accumulated amount of dust in the feature area 110, and stores the estimation result in the storage unit 35 as the dirt information D2 about the feature area 110. When the feature area 110 of the area information D11 is the area 113, the estimation unit 33 estimates synthetic dirt in the feature area 110, and stores the estimation result in the storage unit 35 as the dirt information D2 about the feature area. The synthetic dirt is, for example, a combination of dirt due to a living thing and dirt due to dust.

FIG. 4 is a diagram illustrating an example of the relationship between time and an accumulated amount of dirt of the cleaning area 100 according to the first embodiment. In FIG. 4, the vertical axis represents the accumulated amount of dirt, and the horizontal axis represents time t. Time to presented in FIG. 4 indicates, for example, a clean state in which the cleaning of the cleaning area 100 is finished. The period from the time t₀ to time t₁ indicates that the accumulated amount of dust increases due to absence of the person 300, and the accumulated amount of dirt due to sweat does not change. The time t₁ indicates that the person 300 enters the cleaning area 100 thereby clearing the accumulated amount of dust. The period from the time t₁ to time t₂ indicates that the accumulated amount of dirt due to sweat increases since the person 300 continues to be present, and the accumulated amount of dust does not change. The time t₂ indicates that the person 300 leaves the cleaning area 100 thereby stopping an increase of the accumulated amount of dirt due to sweat. The period from the time t₂ to time t₃ indicates that the accumulated amount of dirt due to sweat does not change due to absence of the person 300, and the accumulated amount of dust increases. The time t₃ indicates that the state in which the person 300 is not present continues, and the accumulated amount of dust exceeds the accumulated amount of dirt due to sweat. In the example illustrated in FIG. 4, the case where the use by the person 300 clear the accumulated amount of dust has been described, but the accumulated amount of dust may be accumulated without being cleared.

Returning to FIG. 1, the estimation unit 33 estimates the dirt information D2 from the image information D1 captured at times different from each other, and stores the dirt information D2 in the storage unit 35 for each time. Accordingly, the dirt information D2 about the feature area 110 in the cleaning area 100 is stored (accumulated) in the storage unit 35 in a time-series manner.

The generation unit 34 generates map information D3 indicating a map of the dirt information D2 about the cleaning area 100 on the basis of the estimated time-series dirt information D2. For example, the generation unit 34 collects, from the storage unit 35, the dirt information D2 from the date and time of the previous cleaning to the latest date and time, and generates the map information D3 about the cleaning area 100 on the basis of the collected dirt information D2. The generation unit 34 generates the map information D3 indicating a map of the time-series dirt information D2 from the date and time of the previous cleaning to the present. The map information D3 includes a map indicating the transition (accumulated amount) of dirt for each feature area 110 in the cleaning area 100. After generating the map information D3, the generation unit 34 stores, in the storage unit 35, the map information D3 and the cleaning area 100 in association with each other.

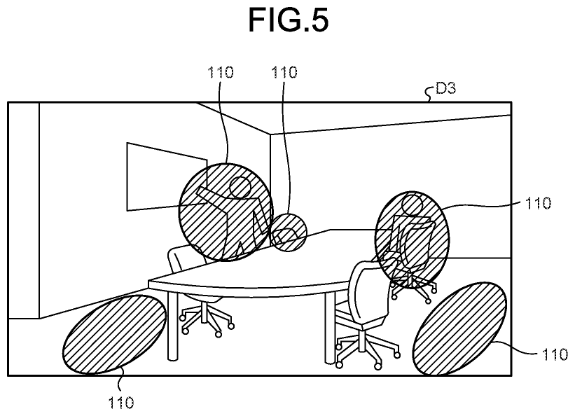

FIG. 5 is a diagram illustrating an example of the map information D3 according to the first embodiment. As illustrated in FIG. 5, the map information D3 is a map indicating the relationship between a three-dimensional image of the room 200 and the feature area 110 extracted in a monitoring period. The monitoring period includes, for example, a period from the end of the previous cleaning to the present, and a set period. In the map information D3, the feature area 110 is an area where the feature is detected in the cleaning area 100. Each of the feature areas 110 in the map information D3 is associated with information indicating the relationship between the time and the accumulated amount of dirt illustrated in FIG. 4. As a result, the map information D3 enables checking the use status of the room 200 with the feature area 110, and checking the relationship between the time and the accumulated amount of dirt of the feature area 110. Note that the map information D3 may be a map indicating the feature area 110 in the planar image of the room 200, a map in which the display mode of the feature area 110 is changed in accordance with the accumulated amount of dirt, or the like.

Returning to FIG. 1, the storage unit 35 stores various data and programs. The storage unit 35 can store various types of information such as the dirt information D2 and the map information D3. The storage unit 35 may store, for example, the image information D1, the measurement information of the sensor unit 20, and the like. The storage unit 35 may store various types of information in association with the cleaning area 100. The storage unit 35 is electrically connected to, for example, the estimation unit 33, the generation unit 34, the management unit 36, and the like. The storage unit 35 is, for example, a semiconductor memory element such as a RAM or a flash memory, a hard disk, or an optical disk. Note that the storage unit 35 may be provided on a cloud server connected to the cleaning area estimation device 30 via the communication unit 40.

The management unit 36 manages the dirt information D2, the map information D3, and the like in the storage unit 35 for each cleaning area 100. The management unit 36 provides, via the communication unit 40, the map information D3 generated by the generation unit 34 to the cleaning robot 500, the electronic device 600, and the like outside the cleaning area estimation device 30. Upon receiving the instruction to output the map information D3 via the communication unit 40, the management unit 36 provides the map information D3 about the corresponding cleaning area 100. For example, the management unit 36 may cause the generation unit 34 to generate and update the map information D3 in response to reception of the output instruction.

The exemplary functional configuration of the cleaning area estimation device 30 according to the first embodiment has been described above. Note that the above-described configurations described with reference to FIG. 1 is merely an example, and the functional configurations of the cleaning area estimation device 30 according to the first embodiment is not limited to the example. The functional configuration of the cleaning area estimation device 30 according to the first embodiment can be flexibly modified according to specifications and operations.

### Processing Procedure of Cleaning Area Estimation Device According to First Embodiment

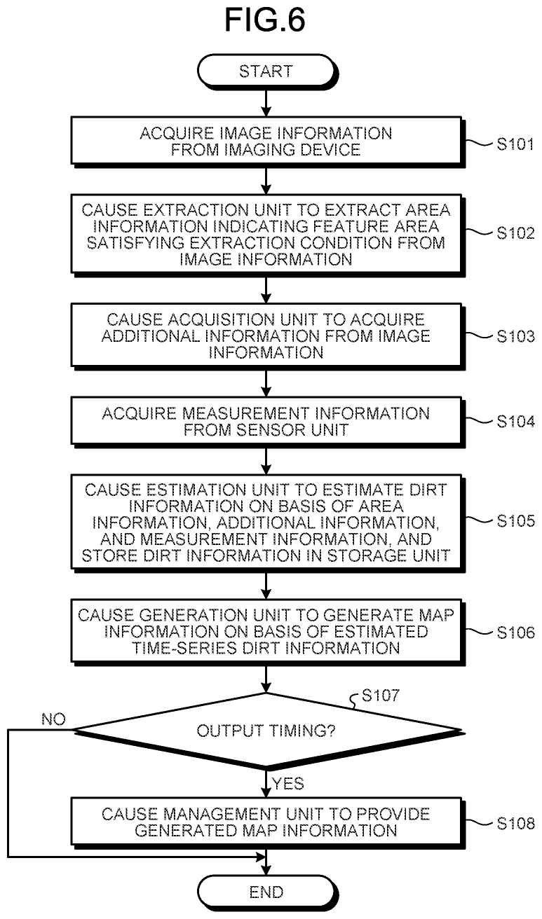

Next, an example of a processing procedure of the cleaning area estimation device 30 according to the first embodiment will be described. FIG. 6 is a flowchart illustrating an example of a processing procedure executed by the cleaning area estimation device 30 according to the first embodiment. The processing procedure illustrated in FIG. 6 is realized by executing a program by the cleaning area estimation device 30. The processing procedure illustrated in FIG. 6 is repeatedly executed by the cleaning area estimation device 30.

As illustrated in FIG. 6, the cleaning area estimation device 30 acquires the image information D1 from the imaging device 10 (Step S101). The cleaning area estimation device 30 causes the extraction unit 31 to extract, from the image information D1, the area information D11 indicating the feature area 110 satisfying the extraction condition (Step S102). For example, the cleaning area estimation device 30 extracts the area information D11 such that the feature area 110 corresponds to the pixel of the image information D1 on a one-to-one basis. In the present embodiment, the area information D11 is a mask image in which the information about the feature area 110 corresponds to the pixel of the image information D1 on a one-to-one basis. The cleaning area estimation device 30 causes the acquisition unit 32 to acquire the additional information D12 from the image information D1 (Step S103).

The cleaning area estimation device 30 acquires the measurement information from the sensor unit 20 (Step S104). The cleaning area estimation device 30 causes the estimation unit 33 to estimate the dirt information D2 on the basis of the area information D11, the additional information D12, and the measurement information, and stores the dirt information D2 in the storage unit 35 (Step S105). For example, the cleaning area estimation device 30 generates the dirt information D2 in which the feature value of the feature area 110 is made for each pixel of the image information D1. When there are a plurality of pieces of the area information D11, the cleaning area estimation device 30 estimates the dirt information D2 for each of the plurality of pieces of the area information D11. When the dirt information D2 is already stored in the storage unit 35, the cleaning area estimation device 30 associates the estimated dirt information D2 with the stored dirt information D2 in the order of time series and stores the estimated dirt information D2 in the storage unit 35.

The cleaning area estimation device 30 causes the generation unit 34 to generate the map information D3 on the basis of the estimated time-series dirt information D2 (Step S106). When the map information D3 about the corresponding cleaning area 100 is stored in the storage unit 35, the cleaning area estimation device 30 updates the map information D3 in the storage unit 35 on the basis of the generated map information D3.

The cleaning area estimation device 30 determines whether or not it is output timing (Step S107). For example, when it is the preset date and time or the like at which output is performed in accordance with an instruction received from the outside, the cleaning area estimation device 30 determines that it is the output timing. When determining that it is not the output timing (No in Step S107), the cleaning area estimation device 30 ends the processing procedure illustrated in FIG. 6.

On the other hand, when determining that it is the output timing (Yes in Step S107), the cleaning area estimation device 30 advances the processing to Step S108. The cleaning area estimation device 30 causes the management unit 36 to provide the generated map information D3 (Step S108). For example, the cleaning area estimation device 30 provides the map information D3 to the cleaning robot 500, the electronic device 600, and the like via the communication unit 40. For example, the cleaning robot 500 cleans the cleaning area 100 that requires cleaning, on the basis of the map information D3 provided from the cleaning area estimation device 30. For example, the electronic device 600 displays the map information D3 provided from the cleaning area estimation device 30 on a display unit to support the determination of the user as to whether or not the place requires cleaning. After providing the map information D3, the cleaning area estimation device 30 ends the processing procedure illustrated in FIG. 6.

As described above, the cleaning area estimation device 30 according to the first embodiment estimates the dirt information D2 about the inside of the cleaning area 100 on the basis of the image information D1 obtained by imaging the cleaning area 100 by the imaging device 10. The cleaning area estimation device 30 generates the map information D3 indicating a map of the dirt information D2 about the cleaning area 100 on the basis of the time-series dirt information D2. Accordingly, the cleaning area estimation device 30 generates the map information D3 using the image information D1 obtained by imaging the cleaning area 100, thereby making it possible to support the determination of necessity of cleaning in the cleaning area 100 by using the map information D3. Furthermore, the cleaning area estimation device 30 generates the map information D3 on the basis of the image information D1 obtained by imaging a plurality of the cleaning area 100, thereby making it possible to support the determination of necessity of cleaning in the plurality of the cleaning area 100. The cleaning area estimation device 30 can support determination of necessity of cleaning in the cleaning area 100 by using the image information D1 of the installed imaging device 10. As a result, the cleaning area estimation device 30 can suppress the time and cost required for the preliminary confirmation of cleaning and enables spending the remaining time to improve the quality of cleaning.

The above-described first embodiment is described as an example, and various modifications and applications can be made.

### Modification of First Embodiment

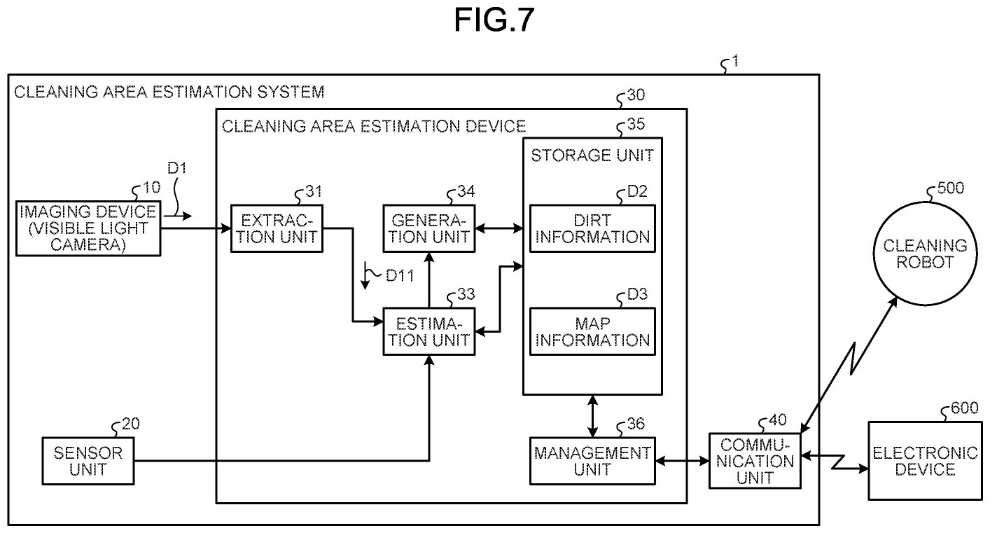

FIG. 7 is a diagram illustrating an example of a configuration of the cleaning area estimation system 1 according to a modification of the first embodiment. As illustrated in FIG. 7, the cleaning area estimation system 1 includes the imaging device 10, the sensor unit 20, the cleaning area estimation device 30, and the communication unit 40. The imaging device 10 is a visible light camera.

The cleaning area estimation device 30 according to the modification of the first embodiment includes the extraction unit 31, the estimation unit 33, the generation unit 34, the storage unit 35, and the management unit 36. That is, the cleaning area estimation device 30 does not include the acquisition unit 32 of the first embodiment.

The extraction unit 31 extracts, as the feature area 110, an area recognized as a human body by analyzing the visible-light image information D1 captured by the visible light camera. The estimation unit 33 estimates the dirt information D2 about the inside of the cleaning area 100 on the basis of the extracted area information D11, temperature, and humidity. For example, the estimation unit 33 estimates the amount of sweat according to the temperature and humidity measured by the sensor unit 20, and stores the estimation result in the storage unit 35 as the dirt information D2 about the feature area 110.

As described above, the cleaning area estimation device 30 according to the modification of the first embodiment extracts the area of a human body as the feature area 110 on the basis of the image information D1 captured by the visible light camera. The cleaning area estimation device 30 estimates, as the dirt information D2, the amount of sweat in the feature area 110 in accordance with the temperature and humidity measured by the sensor unit 20. The cleaning area estimation device 30 generates the map information D3 indicating a map of the dirt information D2 about the cleaning area 100 on the basis of the time-series dirt information D2. Accordingly, also in the case of using a visible light camera, the cleaning area estimation device 30 can generate the map information D3 based on the image information D1 obtained by imaging the cleaning area 100; thus, the cleaning area estimation device 30 can support the determination of necessity of cleaning in the cleaning area 100 by using the map information D3. As a result, the cleaning area estimation device 30 can suppress the time and cost required for the preliminary confirmation of cleaning and enables spending the remaining time to improve the quality of cleaning.

Note that the modification of the first embodiment may be applied to the cleaning area estimation device 30 of other embodiments or modifications.

### Second Embodiment

### Configuration Example of Cleaning Area Estimation System According to Second Embodiment

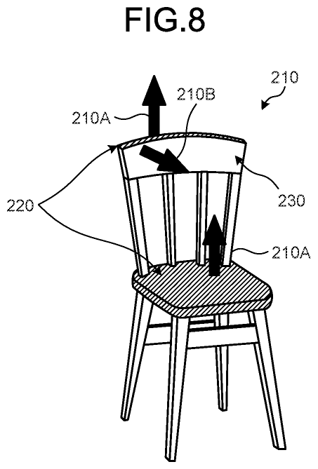

Next, a second embodiment will be described. FIG. 8 is a diagram for explaining the relationship between an object and the degree of ease with which dust accumulates. In the example illustrated in FIG. 8, the closer to the vertical direction a normal line 210A of the surface of an object 210 is, the more easily dust accumulates. Further, the closer to the right angle the angle at which a normal line 210B of the surface of a backrest 230 or the like intersects with the vertical direction is, the less easily dust accumulates. That is, in the object 210, the surface 220 is a portion where dust easily accumulates. It is known that the normal line 210A and the normal line 210B of the object 210 are obtained by acquiring polarization information from reflected light from the object 210. As a method of obtaining the normal line of the object 210, for example, it is possible to refer to the description of Reference Literature 2 “Daisuke Miyazaki and Katsushi Ikeuchi. ‘Basic Theory of Polarization and Its Applications’ Information Processing Society of Japan Transactions on Computer Vision and Image Media (CVIM) 1.1 (2008)”. In the second embodiment, an example of the cleaning area estimation system 1 using a polarization camera will be described.

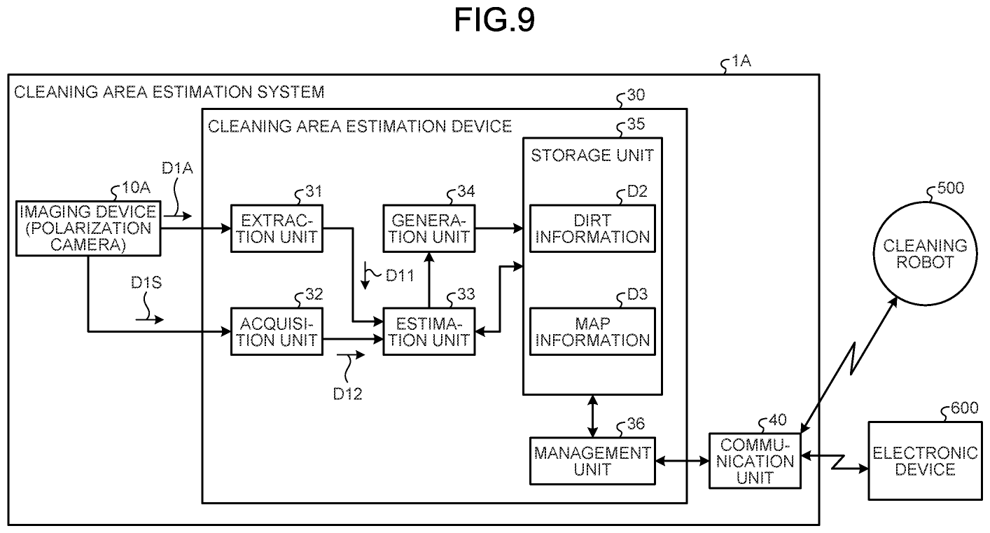

FIG. 9 is a diagram illustrating an example of a configuration of the cleaning area estimation system according to the second embodiment. As illustrated in FIG. 9, a cleaning area estimation system 1A includes an imaging device 10A, the cleaning area estimation device 30, and the communication unit 40.

The imaging device 10A is a polarization camera. The imaging device 10A supplies, to the cleaning area estimation device 30, image information D1A including a polarized image obtained by shooting the cleaning area 100. The image information D1A includes color information and polarization information. The imaging device 10A supplies, to the cleaning area estimation device 30, installation information D1S including an installation direction, an installation position, and the like.

The cleaning area estimation device 30 according to the second embodiment includes the extraction unit 31, the acquisition unit 32, the estimation unit 33, the generation unit 34, the storage unit 35, and the management unit 36.

The extraction unit 31 extracts an area satisfying the extraction condition from the image information D1A of the imaging device 10A. The extraction unit 31 obtains a normal line from the polarization information of the image information D1A, and extracts an area of the surface of the object 210 for which the normal line has been obtained. That is, the extraction condition is an area of the surface of the object 210 for which the normal line has been obtained. The extraction unit 31 supplies, to the estimation unit 33, the area information D11 indicating the area extracted from the image information D1A and the normal line of the area.

The acquisition unit 32 estimates the vertical direction in the image from the installation information D1S of the imaging device 10A. That is, the acquisition unit 32 acquires the additional information D12 indicating the vertical direction from the installation information D1S. The acquisition unit 32 supplies the acquired additional information D12 to the estimation unit 33.

The estimation unit 33 estimates the dirt information D2 about the inside of the cleaning area 100 on the basis of the area information D11 and the additional information D12 of the image information D1A. The estimation unit 33 estimates, for each feature area 110, the dirt information D2 indicating the degree of ease with which dust is deposited on the basis of the relationship between the normal line of the area indicated by the area information D11 and the vertical direction of the additional information D12. For example, when the normal line of the area of the area information D11 is close to the vertical direction, the estimation unit 33 estimates the area of the surface of the object 210 as the dirt information D2 indicating that dust easily accumulates, and stores the dirt information D2 in the storage unit 35. For example, when the normal line of the area of the area information D11 is intersects with the vertical direction, the estimation unit 33 estimates the area of the surface of the object 210 as the dirt information D2 indicating that dust hardly accumulates, and stores the dirt information D2 in the storage unit 35.

The generation unit 34 generates the map information D3 with which deposition of dust on the object 210 in the cleaning area 100 can be identified for each feature area 110 on the basis of the estimated time-series dirt information D2. For example, the generation unit 34 calculates, for each feature area 110, a rate of dust deposition on the basis of the presence or absence of use, an unused time, and the like, and generates the map information D3 indicating a deposition state of dust based on the calculation result as a map for each feature area 110. The map information D3 includes, for example, a map indicating that dust is deposited in the area of the surface 220 of the object 210 illustrated in FIG. 8 and dust is not deposited in the area other than the surface 220 of the object 210. The map information D3 may include, for example, information indicating a deposition amount (accumulated amount) of dust, an elapsed time from cleaning, an elapsed time from use of the object 210, and the like in an area of the surface of the object 210. After generating the map information D3, the generation unit 34 stores, in the storage unit 35, the map information D3 and the cleaning area 100 in association with each other.

The exemplary functional configuration of the cleaning area estimation device 30 according to the second embodiment has been described above. Note that the above-described configurations described with reference to FIG. 9 is merely an example, and the functional configurations of the cleaning area estimation device 30 according to the second embodiment is not limited to the example. The functional configuration of the cleaning area estimation device 30 according to the second embodiment can be flexibly modified according to specifications and operations.

### Processing Procedure of Cleaning Area Estimation Device According to Second Embodiment

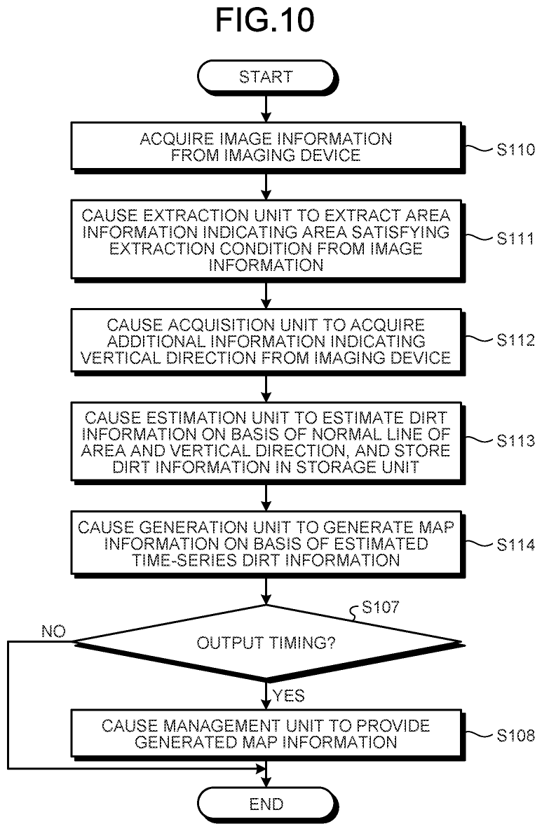

Next, an example of a processing procedure of the cleaning area estimation device 30 according to the second embodiment will be described. FIG. 10 is a flowchart illustrating an example of a processing procedure executed by the cleaning area estimation device 30 according to the second embodiment. The processing procedure illustrated in FIG. 10 is realized by executing a program by the cleaning area estimation device 30. The processing procedure illustrated in FIG. 10 is repeatedly executed by the cleaning area estimation device 30.

As illustrated in FIG. 10, the cleaning area estimation device 30 acquires the image information D1A from the imaging device 10A (Step S110). The cleaning area estimation device 30 causes the extraction unit 31 to extract, from the image information D1A, the area information D11 indicating the area satisfying the extraction condition (Step S111). For example, the cleaning area estimation device 30 extracts the area information D11 such that the area corresponds to the pixel of the image information D1A on a one-to-one basis. In the present embodiment, the area information D11 includes information indicating the normal line and a mask image in which the information about the area corresponds to the pixel of the image information D1A on a one-to-one basis. The cleaning area estimation device 30 causes the acquisition unit 32 to acquire the additional information D12 indicating the vertical direction from the imaging device 10A (Step S112).

The cleaning area estimation device 30 causes the estimation unit 33 to estimate the dirt information D2 on the basis of the normal line of the area and the vertical direction, and stores the dirt information D2 in the storage unit 35 (Step S113). For example, the cleaning area estimation device 30 estimates the dirt information D2 indicating the deposition state of dust in the area on the basis of the relationship between the normal line and the vertical direction. When the dirt information D2 is already stored in the storage unit 35, the cleaning area estimation device 30 associates the estimated dirt information D2 with the stored dirt information D2 in the order of time series and stores the estimated dirt information D2 in the storage unit 35.

The cleaning area estimation device 30 causes the generation unit 34 to generate the map information D3 on the basis of the estimated time-series dirt information D2 (Step S114). When the map information D3 about the corresponding area is stored in the storage unit 35, the cleaning area estimation device 30 updates the map information D3 in the storage unit 35 on the basis of the generated map information D3. After the processing of Step S114 ends, the cleaning area estimation device 30 advances the processing to Step S107 that has been already described.

The cleaning area estimation device 30 determines whether or not it is output timing (Step S107). When determining that it is not the output timing (No in Step S107), the cleaning area estimation device 30 ends the processing procedure illustrated in FIG. 10. On the other hand, when determining that it is the output timing (Yes in Step S107), the cleaning area estimation device 30 advances the processing to Step S108. The cleaning area estimation device 30 causes the management unit 36 to provide the generated map information D3 (Step S108). After providing the map information D3, the cleaning area estimation device 30 ends the processing procedure illustrated in FIG. 10.

As described above, the cleaning area estimation device 30 according to the second embodiment extracts the feature area 110 of the surface of the object 210 from the image information D1A of the imaging device 10A, and estimates the dirt information D2 on the basis of the relationship between the normal line of the feature area 110 and the vertical direction. The cleaning area estimation device 30 generates the map information D3 indicating a map of the dirt information D2 about the cleaning area 100 on the basis of the time-series dirt information D2. Accordingly, the cleaning area estimation device 30 generates the map information D3 using the image information D1A obtained by imaging the cleaning area 100, thereby making it possible to support the determination of necessity of cleaning for the object 210 in the cleaning area 100 by using the map information D3. For example, the cleaning area estimation device 30 can support recognition of a portion of the object 210 where dust is easily deposited, by using the map information D3. As a result, the cleaning area estimation device 30 enables cleaning of a portion of the object 210 where dust is easily deposited, and thus, the cleaning area estimation device 30 can contribute to improvement of the quality of cleaning.

The above-described second embodiment is described as an example, and various modifications and applications can be made. The cleaning area estimation device 30 according to the second embodiment may be applied to other embodiments and the like.

### Third Embodiment

### Configuration Example of Cleaning Area Estimation System According to Third Embodiment

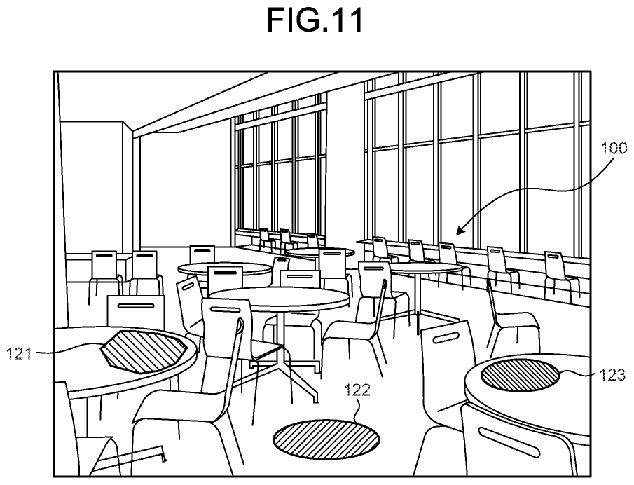

Next, a third embodiment will be described. FIG. 11 is a diagram for explaining an example of dirt in the cleaning area 100. In the example illustrated in FIG. 11, in the cleaning area 100, for example, dirt 121 of coffee exists on the table, dirt 122 of tea exists on the floor, and dirt 123 of ketchup exists on another table. As described above, in the cleaning area 100, various dirt such as beverages, seasonings, and foods may exist, for example. It is known that a component of an observed substance can be analyzed from an image captured by a spectral camera. For example, it is possible to refer to the description of Reference Literature 3 “Miyuki KONDO. ‘Food Analysis by Near-Infrared Spectroscopy’, Journal of Nagoya Bunri University 7 (2007)”. In the third embodiment, an example of the cleaning area estimation system 1 using a spectral camera will be described.

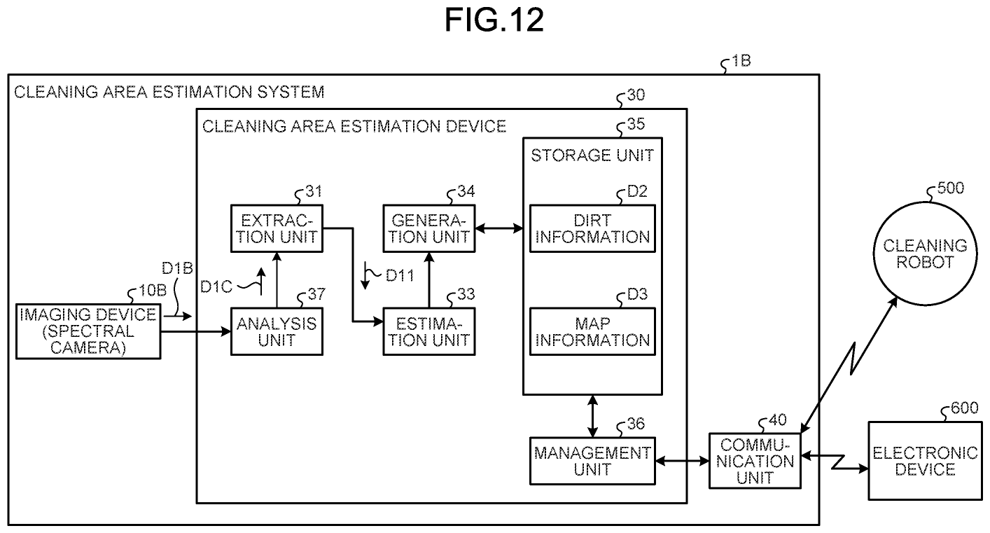

FIG. 12 is a diagram illustrating an example of a configuration of a cleaning area estimation system according to the third embodiment. As illustrated in FIG. 12, a cleaning area estimation system 1B includes an imaging device 10B, the cleaning area estimation device 30, and the communication unit 40.

The imaging device 10B is a spectral camera. The imaging device 10B spectrally disperses and detects light in the vertical direction as one horizontal line, using optical components such as a diffraction grating and a mirror. The imaging device 10B captures a two-dimensional spectral image for each wavelength of light by performing the above-described spectral dispersion and detection in the horizontal direction. The imaging device 10B supplies, to the cleaning area estimation device 30, image information D1B indicating a spectral image obtained by shooting the cleaning area 100. The image information D1B includes an image in a normal visible light band and a spectral image obtained by finely dividing the wavelength of light related to the cleaning area 100 into a plurality of wavelengths and detecting the plurality of wavelengths.

The cleaning area estimation device 30 according to the third embodiment includes the extraction unit 31, the estimation unit 33, the generation unit 34, the storage unit 35, the management unit 36, and an analysis unit 37.

The analysis unit 37 analyzes a component for each pixel from the spectral image of the imaging device 10B and generates a component map. The analysis unit 37 estimates the type of dirt from the component map and generates dirt type information D1C. For example, the analysis unit 37 estimates the type of dirt from the component map on the basis of model data for recognizing machine-learned dirt (food). The model data includes, for example, data indicating the relationship between a component and food. In the example illustrated in FIG. 11, the analysis unit 37 estimates that the dirt 121 is coffee, the dirt 122 is tea, and the dirt 122 is ketchup. The analysis unit 37 generates the dirt type information D1C indicating the estimated result and associated with the component map. The dirt type information D1C includes the image information D1B of the imaging device 10B, but may not include the image information D1B. The analysis unit 37 supplies the generated dirt type information D1C to the extraction unit 31.

The extraction unit 31 extracts an area satisfying the extraction condition from the image information D1B of the imaging device 10B on the basis of the dirt type information D1C of the analysis unit 37. The extraction unit 31 extracts the area including dirt from the dirt type information D1C for each of the same or similar types. That is, the extraction condition is a condition for classifying the type of dirt. For example, in the cleaning area 100, the extraction unit 31 extracts areas of each of the dirt 121, the dirt 122, and the dirt 123 illustrated in FIG. 11. The extraction unit 31 supplies, to the estimation unit 33, the area information D11 indicating the extracted area.

The estimation unit 33 estimates the dirt information D2 indicating the type of area and the area of dirt in the cleaning area 100 on the basis of the area information D11 and the dirt type information D1C of the image information D1B. For example, the estimation unit 33 estimates the dirt information D2 indicating the type and state of dirt for each area indicated by the area information D11, and stores the dirt information D2 in the storage unit 35.

Based on the estimated time-series dirt information D2, the generation unit 34 generates the map information D3 indicating a map by areas, with which the type and state of dirt in the cleaning area 100 can be identified. For example, the generation unit 34 estimates the degree of dryness of dirt by comparing the date and time when the dirt is attached with the current date and time, and estimates the amount and type of dirt by areas. For example, on the basis of the dirt information D2 in the monitoring period, the generation unit 34 measures how much dirt of the same type is left. Then the generation unit 34 estimates the dry state of the dirt, and generates the map information D3 indicating the type and state of the dirt on the map. The map information D3 includes, for example, information for displaying information indicating an area of dirt, a type of dirt, and a dry state of dirt on a map of the cleaning area 100. After generating the map information D3, the generation unit 34 stores, in the storage unit 35, the map information D3 and the cleaning area 100 in association with each other.

The exemplary functional configuration of the cleaning area estimation device 30 according to the third embodiment has been described above. Note that the above-described configurations described with reference to FIG. 12 is merely an example, and the functional configurations of the cleaning area estimation device 30 according to the third embodiment is not limited to the example. The functional configuration of the cleaning area estimation device 30 according to the third embodiment can be flexibly modified according to specifications and operations.

### Processing Procedure of Cleaning Area Estimation Device According to Third Embodiment

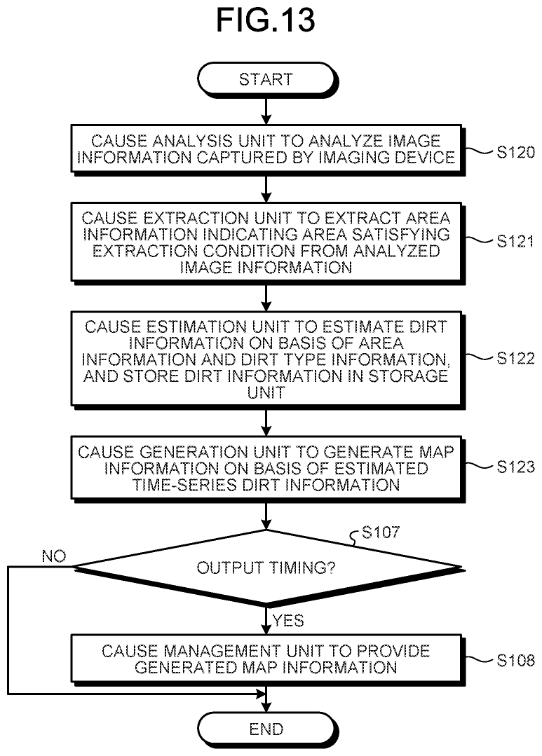

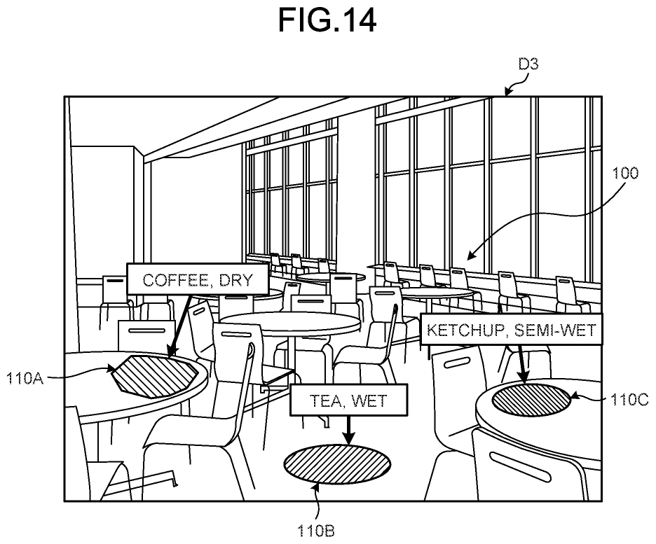

Next, an example of a processing procedure of the cleaning area estimation device 30 according to the third embodiment will be described. FIG. 13 is a flowchart illustrating an example of a processing procedure executed by the cleaning area estimation device 30 according to the third embodiment. FIG. 14 is a diagram illustrating an example of map information generated by the cleaning area estimation device 30 according to the third embodiment. The processing procedure illustrated in FIG. 13 is realized by executing a program by the cleaning area estimation device 30. The processing procedure illustrated in FIG. 13 is repeatedly executed by the cleaning area estimation device 30.

As illustrated in FIG. 13, the cleaning area estimation device 30 causes the analysis unit 37 to analyze the image information D1B captured by the imaging device 10B (Step S120). After estimating the type of dirt from the component map and generating the dirt type information D1C, the cleaning area estimation device 30 advances the processing to Step S121.

The cleaning area estimation device 30 causes the extraction unit 31 to extract, from the analyzed image information D1B, the area information D11 indicating the area satisfying the extraction condition (Step S121). For example, the cleaning area estimation device 30 extracts the area information D11 such that the area corresponds to the pixel of the image information D1B on a one-to-one basis. In the present embodiment, the area information D11 includes information indicating a mask image in which the information about the area corresponds to the pixel of the image information D1B on a one-to-one basis.

The cleaning area estimation device 30 causes the estimation unit 33 to estimate the dirt information D2 on the basis of the area information D11 and the dirt type information D1C, and stores the dirt information D2 in the storage unit 35 (Step S122). For example, the cleaning area estimation device 30 estimates the dirt information D2 indicating the type of area and the state of dirt in the cleaning area 100. When the dirt information D2 is already stored in the storage unit 35, the cleaning area estimation device 30 associates the estimated dirt information D2 with the stored dirt information D2 in the order of time series and stores the estimated dirt information D2 in the storage unit 35.

The cleaning area estimation device 30 causes the generation unit 34 to generate the map information D3 on the basis of the time-series dirt information D2 estimated in Step S122 (Step S123). For example, the cleaning area estimation device 30 estimates the dry state of the dirt for each area indicated by the time-series dirt information D2 on the basis of the type of dirt, the time during which the dirt is left, and the model data. The model data includes, for example, data for estimating a state such as dryness, semi-wetting, or wetting on the basis of the type and the elapsed time. The model data includes, for example, a calculation formula for calculating the dry state on the basis of the type of dirt and the elapsed time, data such as a table for conversion, and a program. The cleaning area estimation device 30 generates the map information D3 in which the state information indicating the type of dirt and the dry state is associated with the area.

In the example illustrated in FIG. 14, the cleaning area estimation device 30 generates the map information D3 including state information indicating that the type of a feature area 110A is coffee and the state of dirt is dry. The cleaning area estimation device 30 generates the map information D3 including state information indicating that the type of a feature area 110B is tea and the state of dirt is wet. The cleaning area estimation device 30 generates the map information D3 including state information indicating that the type of a feature area 110C is ketchup and the state of dirt is semi-wet. As a result, the cleaning area estimation device 30 enables checking the type and state of dirt with the map information D3 for each feature area 110.

Returning to FIG. 13, when the map information D3 about the corresponding area is stored in the storage unit 35, the cleaning area estimation device 30 updates the map information D3 in the storage unit 35 on the basis of the generated map information D3. After the processing of Step S123 ends, the cleaning area estimation device 30 advances the processing to Step S107 that has been already described.

The cleaning area estimation device 30 determines whether or not it is output timing (Step S107). When determining that it is not the output timing (No in Step S107), the cleaning area estimation device 30 ends the processing procedure illustrated in FIG. 13. On the other hand, when determining that it is the output timing (Yes in Step S107), the cleaning area estimation device 30 advances the processing to Step S108. The cleaning area estimation device 30 causes the management unit 36 to provide the generated map information D3 (Step S108). After providing the map information D3, the cleaning area estimation device 30 ends the processing procedure illustrated in FIG. 13.

As described above, the cleaning area estimation device 30 according to the third embodiment analyzes the image information D1B of the imaging device 10B, and estimates the dirt information D2 about the feature area extracted from the image information D1B. Based on the time-series dirt information D2, the cleaning area estimation device 30 generates the map information D3 with which the type and state of dirt of the feature area 110 in the cleaning area 100 can be identified. Accordingly, the cleaning area estimation device 30 generates the map information D3 using the image information D1B obtained by imaging the cleaning area 100, thereby making it possible to support the determination of the type of cleaning based on the type and state of dirt of the cleaning area 100 by using the map information D3. As a result, the cleaning area estimation device 30 enables cleaning suitable for the feature area 110, and thus, the cleaning area estimation device 30 can contribute to improvement of the work efficiency of cleaning.

The above-described third embodiment is described as an example, and various modifications and applications can be made. The cleaning area estimation device 30 according to the third embodiment may be applied to other embodiments and the like.

[Hardware Configuration]

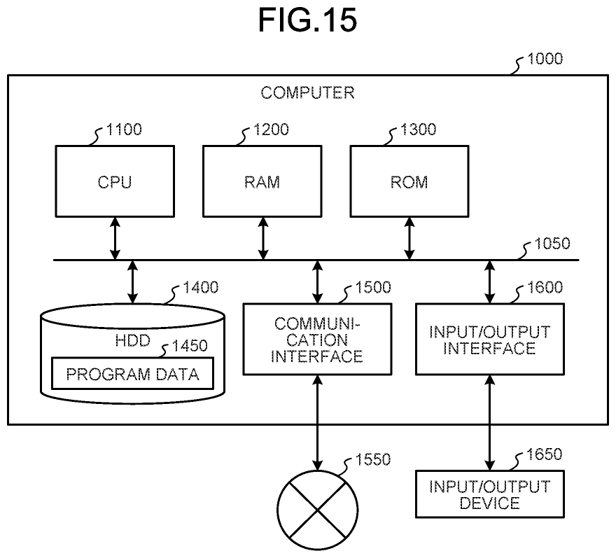

The cleaning area estimation device 30 according to the present embodiment described above may be implemented by a computer 1000 having a configuration as illustrated in FIG. 15, for example. Hereinafter, the cleaning area estimation device 30 according to the embodiments will be described as an example. FIG. 15 is a hardware configuration diagram illustrating an example of the computer 1000 that implements functions of the cleaning area estimation device 30. The computer 1000 includes a CPU 1100, a RAM 1200, a read only memory (ROM) 1300, a hard disk drive (HDD) 1400, a communication interface 1500, and an input/output interface 1600. Each unit of the computer 1000 is coupled through a bus 1050.

The CPU 1100 operates on the basis of a program stored in the ROM 1300 or the HDD 1400, and controls each unit. For example, the CPU 1100 develops a program stored in the ROM 1300 or the HDD 1400 to the RAM 1200, and executes processing corresponding to various programs.

The ROM 1300 stores a boot program such as a basic input output system (BIOS) executed by the CPU 1100 when the computer 1000 is activated, and stores a program depending on hardware of the computer 1000, and the like.

The HDD 1400 is a computer-readable recording medium that non-transiently records a program executed by the CPU 1100, data used by the program, and the like. Specifically, the HDD 1400 is a recording medium that records an information processing program according to the present disclosure, which is an example of program data 1450.

The communication interface 1500 is an interface for the computer 1000 to connect to an external network 1550 (for example, the Internet). For example, the CPU 1100 receives data from another device or transmits data generated by the CPU 1100 to another device via the communication interface 1500.

The input/output interface 1600 is an interface for coupling an input/output device 1650 and the computer 1000. For example, the CPU 1100 receives data from an input device such as a keyboard or a mouse via the input/output interface 1600. In addition, the CPU 1100 transmits data to an output device such as a display, a speaker, or a printer via the input/output interface 1600. Furthermore, the input/output interface 1600 may function as a media interface that reads a program or the like recorded in a predetermined recording medium (medium). Examples of the medium include an optical recording medium such as a digital versatile disc (DVD); a magneto-optical recording medium such as a magneto-optical disk (MO); a tape medium; a magnetic recording medium; and a semiconductor memory.

For example, when the computer 1000 functions as the cleaning area estimation device 30 according to the embodiment, the CPU 1100 of the computer 1000 implements the functions of the extraction unit 31, the acquisition unit 32, the estimation unit 33, the generation unit 34, the management unit 36, the analysis unit 37, and the like of the cleaning area estimation device 30, by executing the program loaded on the RAM 1200. In addition, the HDD 1400 stores the program according to the present disclosure and data in the storage unit 35. Note that the CPU 1100 reads the program data 1450 from the HDD 1400 and executes the program data. As another example, these programs may be acquired from another device via the external network 1550.

Although the preferred embodiments of the present disclosure have been described in detail with reference to the accompanying drawings, the technical scope of the present disclosure is not limited to the foregoing examples. It is obvious that a person who has common knowledge in the technical field of the present disclosure may, within the scope of the technical idea recited in the claims, conceive various alterations or modifications, and it should be understood that they also naturally belong to the technical scope of the present disclosure.

Furthermore, the effects described herein are merely illustrative or exemplary, and are not limitative. That is, the technology according to the present disclosure may, with or in lieu of the foregoing effects, exhibit other effects obvious to those skilled in the art from the description provided herein.

In addition, it is also possible to create a program for causing hardware such as a CPU, a ROM, and a RAM built in a computer to exhibit functions equivalent to the configurations of the cleaning area estimation device 30, and a computer-readable recording medium in which this program is recorded may also be provided.

Furthermore, each step pertaining to the processing of the cleaning area estimation device 30 provided herein is not necessarily processed in a time-series manner in the order illustrated in the flowchart. For example, each step pertaining to the processing of the cleaning area estimation device 30 may be processed in an order different from the order illustrated in the flowchart, or may be processed in parallel.

In the foregoing embodiments, the case where the cleaning area estimation device 30 is included in the cleaning area estimation systems 1, 1A, and 1B has been described, but the present disclosure is not limited thereto. For example, the cleaning area estimation device 30 may be implemented by the cleaning robot 500, the electronic device 600, a monitoring device of a building, or the like. For example, when implemented by the cleaning robot 500, the cleaning area estimation device 30 can be implemented by a control device of the cleaning robot 500.

(Effects)

The cleaning area estimation device 30 includes the estimation unit 33 that estimates the dirt information D2 about the inside of the cleaning area 100 on the basis of the image information D1 obtained by imaging the cleaning area 100 by the imaging device 10, and the generation unit 34 that generates the map information D3 indicating a map of the dirt information D2 about the cleaning area 100 on the basis of the estimated time-series dirt information D2.

Accordingly, the cleaning area estimation device 30 generates the map information D3 about the dirt information D2 using the image information D1 obtained by imaging the cleaning area 100, thereby making it possible to support the determination of necessity of cleaning in the cleaning area 100 by using the map information D3. As a result, the cleaning area estimation device 30 can suppress the time and cost required for the preliminary confirmation of cleaning and enables spending the remaining time to improve the quality of cleaning.

The cleaning area estimation device 30 further includes the extraction unit 31 that extracts the feature area 110 satisfying the extraction condition from the image information D1, and the estimation unit 33 estimates the dirt information D2 on the basis of the feature of feature area 110.

Accordingly, the cleaning area estimation device 30 extracts the feature area 110 satisfying the extraction condition from the image information D1, thereby making it possible to generate the map information D3 suitable for the determination of necessity of cleaning in the cleaning area 100. As a result, the cleaning area estimation device 30 can improve accuracy in the determination of necessity of cleaning in the cleaning area 100, and thus, the cleaning area estimation device 30 can contribute to improvement of the work efficiency of cleaning.

In the cleaning area estimation device 30, the extraction condition is a condition for extracting an area of a living thing in the cleaning area 100.

Accordingly, the cleaning area estimation device 30 extracts the area of a living thing in the cleaning area 100 from the image information D1, thereby making it possible to generate the map information D3 suitable for the determination of necessity of cleaning in the feature area 110 that has been dirtied by the living thing. As a result, the cleaning area estimation device 30 can improve accuracy in the determination of necessity of cleaning with respect to dirt due to a living thing in the cleaning area 100, and thus, the cleaning area estimation device 30 can contribute to improvement of the quality of cleaning.

In the cleaning area estimation device 30, the estimation unit 33 estimates the dirt information D2 about dirt due to a living thing on the basis of the feature of the feature area 110 and at least one of the temperature and the humidity of the cleaning area 100 detected by the sensor unit 20. The dirt information D2 includes information indicating at least one of the type of dirt, the accumulated amount of dirt, and the state of dirt.

As a result, the cleaning area estimation device 30 can generate the map information D3 indicating the dirt information D2 about dirt due to the living thing, which is estimated on the basis of the environment in the cleaning area 100. As a result, the cleaning area estimation device 30 can improve accuracy in the determination of necessity of cleaning with respect to dirt due to a living thing on the basis of at least one of the type of dirt, the accumulated amount of dirt, and the state of dirt; thus, the cleaning area estimation device 30 can contribute to further improvement of the quality of cleaning.

The cleaning area estimation device 30 further includes the extraction unit 31 that extracts the feature area 110 satisfying the extraction condition of the object 210 in the cleaning area 100 on the basis of the polarized image included in the image information D1A. The estimation unit 33 estimates the dirt information D2 indicating the degree of ease with which dust is deposited on the object 210 on the basis of the relationship between the normal line of the feature area 110 and the vertical direction. The generation unit 34 generates the map information D3 with which the estimated deposition state of dust on the object 210 in the feature area 110 can be identified.

Accordingly, the cleaning area estimation device 30 generates the map information D3 using the image information D1A obtained by imaging the cleaning area 100, thereby making it possible to support the determination of necessity of cleaning for the object 210 in the cleaning area 100 by using the map information D3. As a result, the cleaning area estimation device 30 enables cleaning of a portion of the object 210 where dust is easily deposited, and thus, the cleaning area estimation device 30 can contribute to improvement of the quality of cleaning.

The cleaning area estimation device 30 further includes the acquisition unit 32 that acquires the vertical direction in the image indicated by the image information D1A from the installation information D1S of the imaging device 10A.

Accordingly, the cleaning area estimation device 30 acquires the vertical direction in the image information D1A from the installation information D1S, thereby making it possible to improve the accuracy of the dirt information D2 indicating the degree of ease with which dust is deposited on the object 210. As a result, the cleaning area estimation device 30 can improve the accuracy in estimation of a portion of the object 210 where dust is easily deposited, and thus, the cleaning area estimation device 30 can contribute to further improvement of the quality of cleaning.

The cleaning area estimation device 30 further includes the analysis unit 37 that analyzes a dirt component in the cleaning area 100 on the basis of a spectral image included in the image information D1B, and the extraction unit 31 that extracts the feature area 110 satisfying the extraction condition from the image information D1B on the basis of the analyzed dirt component. The estimation unit 33 estimates the dirt information D2 indicating a type of the feature area 110 on the basis of the analyzed dirt component. The generation unit 34 generates the map information D3 with which at least one of a type and a state of dirt in the cleaning area 100 can be identified.

Accordingly, the cleaning area estimation device 30 generates the map information D3 using the image information D1B obtained by imaging the cleaning area 100, thereby making it possible to support the determination of the type of cleaning based on the type and state of dirt of the cleaning area 100 by using the map information D3. As a result, the cleaning area estimation device 30 enables cleaning suitable for the feature area 110, and thus, the cleaning area estimation device 30 can contribute to improvement of the work efficiency of cleaning.

In the cleaning area estimation device 30, the generation unit 34 generates the map information D3 indicating the dry state of dirt on the basis of the time-series dirt information D2 after the dirt is generated.

Accordingly, the cleaning area estimation device 30 generates the map information D3 indicating the dry state of dirt, thereby making it possible to support the determination of the type of cleaning based on the dry state of dirt of the cleaning area 100 by using the map information D3. As a result, the cleaning area estimation device 30 enables cleaning suitable for the dry state of dirt of the feature area 110, and thus, the cleaning area estimation device 30 can contribute to improvement of the quality of cleaning.

The cleaning area estimation device 30 further includes the management unit 36 that manages provision of the map information D3.

Accordingly, the cleaning area estimation device 30 can manage the timing of generation, output, and the like of the map information D3 by managing the provision of the map information D3. As a result, the cleaning area estimation device 30 can provide the map information D3 suitable for determination of cleaning, and thus, the cleaning area estimation device 30 can contribute to further improvement of the quality of cleaning.

A method for estimating a cleaning area includes estimating, by a computer, the dirt information D2 about the inside of the cleaning area 100 on the basis of the image information D1 obtained by imaging the cleaning area 100 by the imaging device 10, and generating, by the computer, the map information D3 indicating a map of the dirt information D2 about the cleaning area 100 on the basis of the estimated time-series dirt information D2.

Accordingly, the method for estimating a cleaning area causes a computer to generate the map information D3 about the dirt information D2 using the image information D1 obtained by imaging the cleaning area 100, thereby making it possible to support the determination of necessity of cleaning in the cleaning area 100 by using the map information D3. As a result, the method for estimating a cleaning area can suppress the time and cost required for the preliminary confirmation of cleaning and enables spending the remaining time to improve the quality of cleaning.

Note that the following configurations also belong to the technical scope of the present disclosure.

(1)

A cleaning area estimation device including:

an estimation unit configured to estimate dirt information about an inside of a cleaning area on a basis of image information obtained by imaging the cleaning area by an imaging device; and

a generation unit configured to generate map information indicating a map of the dirt information about the cleaning area on a basis of the dirt information that is estimated and in a time series.

(2)

The cleaning area estimation device according to (1), further including

an extraction unit configured to extract a feature area satisfying an extraction condition from the image information,

wherein the estimation unit estimates the dirt information on a basis of a feature of the feature area.

(3)

The cleaning area estimation device according to (2), wherein the extraction condition is a condition for extracting an area of a living thing in the cleaning area.

(4)

The cleaning area estimation device according to (2) or

(3), wherein

the estimation unit estimates the dirt information about dirt due to the living thing on a basis of the feature of the feature area and at least one of temperature and humidity of the cleaning area detected by a sensor unit, and

the dirt information includes information indicating at least one of a type of dirt, an accumulated amount of dirt, and a state of dirt.

(5)

The cleaning area estimation device according to (1), further including

an extraction unit configured to extract a feature area satisfying an extraction condition of an object in the cleaning area on a basis of a polarized image included in the image information,

wherein the estimation unit estimates the dirt information indicating a degree of ease with which dust is deposited on the object on a basis of a relationship between a normal line of the feature area and a vertical direction, and

the generation unit generates the map information with which an estimated deposition state of dust on the feature area of the object can be identified.

(6)

The cleaning area estimation device according to (5), further including

an acquisition unit configured to acquire the vertical direction in an image indicated by the image information from installation information of the imaging device.

(7)

The cleaning area estimation device according to (1), further including:

an analysis unit configured to analyze a dirt component in the cleaning area on a basis of a spectral image included in the image information; and

an extraction unit configured to extract a feature area satisfying an extraction condition from the image information on a basis of the analyzed dirt component,

wherein the estimation unit estimates the dirt information indicating a type of the feature area on a basis of the analyzed dirt component, and

the generation unit generates the map information with which at least one of a type and a state of dirt in the cleaning area can be identified.

(8)

The cleaning area estimation device according to (7), wherein

the generation unit generates the map information indicating a dry state of the dirt on a basis of the dirt information in a time series after the dirt is generated.

(9)

The cleaning area estimation device according to any one of (1) to (8), further including

a management unit configured to manage provision of the map information.

(10)

A method for estimating a cleaning area including:

estimating, by a computer, dirt information about an inside of a cleaning area on a basis of image information obtained by imaging a cleaning area by an imaging device; and

generating, by the computer, map information indicating a map of the dirt information about the cleaning area on a basis of the dirt information that is estimated and in a time series.

(11)

A program causing a computer to perform: estimating dirt information about an inside of a cleaning area on a basis of image information obtained by imaging the cleaning area by an imaging device; and generating map information indicating a map of the dirt information about the cleaning area on a basis of the dirt information that is estimated and in a time series.

(12)

A cleaning area estimation system including: an imaging device configured to image a cleaning area; and a cleaning area estimation device, in which the cleaning area estimation device includes an estimation unit configured to estimate dirt information about an inside of the cleaning area on a basis of image information obtained by imaging the cleaning area by the imaging device, and a generation unit configured to generate map information indicating a map of the dirt information about the cleaning area on a basis of the dirt information that is estimated and in a time series.

### REFERENCE SIGNS LIST

1, 1A, 1B CLEANING AREA ESTIMATION SYSTEM
10, 10A, 10B IMAGING DEVICE
20 SENSOR UNIT
30 CLEANING AREA ESTIMATION DEVICE
31 EXTRACTION UNIT
32 ACQUISITION UNIT
33 ESTIMATION UNIT
34 GENERATION UNIT
35 STORAGE UNIT
36 MANAGEMENT UNIT
37 ANALYSIS UNIT
40 COMMUNICATION UNIT
100 CLEANING AREA
110 FEATURE AREA
D1, D1A, D1B IMAGE INFORMATION
D2 DIRT INFORMATION
D3 MAP INFORMATION
D11 AREA INFORMATION
D12 ADDITIONAL INFORMATION

1. A cleaning area estimation device including:
an estimation unit configured to estimate dirt information about an inside of a cleaning area on a basis of image information obtained by imaging the cleaning area by an imaging device; and
a generation unit configured to generate map information indicating a map of the dirt information about the cleaning area on a basis of the dirt information that is estimated and in a time series.

2. The cleaning area estimation device according to claim 1, further including
an extraction unit configured to extract a feature area satisfying an extraction condition from the image information,
wherein the estimation unit estimates the dirt information on a basis of a feature of the feature area.

3. The cleaning area estimation device according to claim 2, wherein the extraction condition is a condition for extracting an area of a living thing in the cleaning area.

4. The cleaning area estimation device according to claim 3, wherein
the estimation unit estimates the dirt information about dirt due to the living thing on a basis of the feature of the feature area and at least one of temperature and humidity of the cleaning area detected by a sensor unit, and
the dirt information includes information indicating at least one of a type of dirt, an accumulated amount of dirt, and a state of dirt.

5. The cleaning area estimation device according to claim 1, further including
an extraction unit configured to extract a feature area satisfying an extraction condition of an object in the cleaning area on a basis of a polarized image included in the image information,
wherein the estimation unit estimates the dirt information indicating a degree of ease with which dust is deposited on the object on a basis of a relationship between a normal line of the feature area and a vertical direction, and
the generation unit generates the map information with which an estimated deposition state of dust on the feature area of the object can be identified.

6. The cleaning area estimation device according to claim 5, further including
an acquisition unit configured to acquire the vertical direction in an image indicated by the image information from installation information of the imaging device.

7. The cleaning area estimation device according to claim 1, further including:
an analysis unit configured to analyze a dirt component in the cleaning area on a basis of a spectral image included in the image information; and
an extraction unit configured to extract a feature area satisfying an extraction condition from the image information on a basis of the analyzed dirt component,
wherein the estimation unit estimates the dirt information indicating a type of the feature area on a basis of the analyzed dirt component, and
the generation unit generates the map information with which at least one of a type and a state of dirt in the cleaning area can be identified.

8. The cleaning area estimation device according to claim 7, wherein
the generation unit generates the map information indicating a dry state of the dirt on a basis of the dirt information in a time series after the dirt is generated.

9. The cleaning area estimation device according to claim 1, further including
a management unit configured to manage provision of the map information.

10. A method for estimating a cleaning area including:
estimating, by a computer, dirt information about an inside of a cleaning area on a basis of image information obtained by imaging a cleaning area by an imaging device; and
generating, by the computer, map information indicating a map of the dirt information about the cleaning area on a basis of the dirt information that is estimated and in a time series.
